(19) United States
(12) Patent Application Publication
(10) Pub. No.: US 2025/0036894 A1
(43) Pub. Date: Jan. 30, 2025

(54) ANTENNA ARRANGEMENT

(71) Applicant: MAERSK A/S, Copenhagen K (DK)

(72) Inventors: Find BENGTSSON, Copenhagen K (DK); Peter CHRISTIANSEN, Copenhagen K (DK); Tero KONTKANEN, Copenhagen K (DK); Jari Tapani TOIVANEN, Copenhagen K (DK); Joni KORPPI, Copenhagen K (DK)

(21) Appl. No.: 18/913,216

(22) Filed: Oct. 11, 2024

Related U.S. Application Data
(63) Continuation of application No. PCT/EP2023/059389, filed on Apr. 11, 2023.

(30) Foreign Application Priority Data
Apr. 11, 2022 (DK) PA202200345

(51) Int. Cl. G06K 7/10

(52) U.S. Cl. CPC G06K 7/10316; G06K 7/10178

(57) ABSTRACT

Disclosed is a system including an antenna arrangement and a communication device. The antenna arrangement includes a first antenna portion located internally within an enclosure and a second antenna portion located externally of the enclosure. The communication device is located externally of the enclosure and includes a device antenna. The second antenna portion is configured to be located in a near-field region of the device antenna such that the device antenna and the second antenna portion couple to one another to transmit signals between the communication device and the antenna arrangement.

### CROSS-REFERENCE TO RELATED APPLICATIONS

This application is a continuation under 35 U.S.C. § 120 of International Application No. PCT/EP2023/059389, filed Apr. 11, 2023, which claims priority to Denmark (DK) Application No. PA202200345, filed Apr. 11, 2022 under 35 U.S.C. § 119 (a). Each of the above-referenced patent applications is incorporated by reference in its entirety.

### TECHNICAL FIELD

The present invention relates to systems comprising an antenna arrangement and a communication device, and a transportation unit comprising such systems.

### BACKGROUND

End-to-end logistics includes the procurement, distribution and delivery of goods. The goods may be stored and/or transported in enclosures. For example, shipping containers may be used to store and/or transport goods between various locations. Alternatively, the enclosures may be a part of a vehicle (such as an aircraft, a marine vessel, a train or a motor vehicle) or may be another enclosed space. It may be desirable to monitor the status and/or properties of the enclosures and/or their contents.

### SUMMARY

According to a first aspect of the present invention, there is provided a system comprising: an antenna arrangement comprising: a first antenna portion located internally within an enclosure; and a second antenna portion located externally of the enclosure; and a communication device located externally of the enclosure, the communication device comprising a device antenna; wherein the second antenna portion is located in a near-field region of the device antenna such that the device antenna and the second antenna portion couple to one another to transmit signals between the communication device and the antenna arrangement.

In this way, the coupling between the device antenna and the second antenna portion may result in a greater and/or more predictable signal strength of the signals transmitted between the communication device and the antenna arrangement. This may improve the quality of the transmission of the signals into and out of the enclosure.

Optionally, the device antenna is located in a near-field region of the second antenna portion. In this way, the second antenna portion may be coupled to the device antenna when the second antenna portion emits signals.

Optionally, the system comprises a further communication device located internally within the enclosure, and the antenna arrangement is configured to transmit signals between the first antenna portion and the further communication device. In this way, the communication device located externally of the enclosure can communicate with the further communication device located internally within the enclosure.

Optionally, the further communication device comprises at least one of: a sensor or an identification module. Optionally, the sensor comprises a temperature sensor to determine a temperature within the enclosure. Optionally, the sensor comprises a vibration sensor, a shock sensor, a gas sensor (e.g. CO₂, CO, O₂, etc), a light sensor, a humidity sensor or an event sensor (e.g. an event triggered sensor such as a break-beam sensor). This may enable the communication device, which is located externally of the enclosure, to obtain information indicative of a property and/or status of the enclosure and/or its contents. For example, the enclosure may be a refrigerated container and the temperature sensor may provide information indicative of a temperature inside the refrigerated container. This may allow the temperature to be monitored and controlled depending on the contents of the container.

Optionally, the further communication device is connected to an actuator. Optionally, the actuator is configured to actuate a lock on the enclosure. This may allow the lock to be controlled remotely from the enclosure. Moreover, the status of the lock may be monitored remotely from the enclosure. This may help to determine whether the integrity of enclosure may have been compromised in some way.

Optionally, the further communication device is located in a far-field region of the first antenna portion. This may allow the signal from the first antenna portion to be transmitted over a relatively large distance, e.g. at least the length of the enclosure. The further communication device may also have improved signal strength to the first antenna portion as compared to directly to the communication device (i.e. without the antenna arrangement). This may help to improve the quality and/or strength of the signal between the communication device and the further communication device through the use of the antenna arrangement.

Optionally, the near-field region of the device antenna is a distance from the device antenna that is less than or equal to a wavelength of the transmitted signals. Optionally, the near-field region of the second antenna portion is a distance from the second antenna portion that is less than or equal to a wavelength of the transmitted signals.

Optionally, the first antenna portion is connected to the second antenna portion by a galvanic connection. This may provide a direct electrical connection between the first antenna portion and the second antenna portion, which may help to increase the quality and/or strength of the signal transferred between the first antenna portion and the second antenna portion.

Optionally, the first antenna portion and the second antenna portion are asymmetric. This may allow the sizes and/or shapes of the first and second antenna portions to be individually tailored as desired. For example, the first antenna portion may be shaped such that it does not interfere with the contents of the enclosure, while the second antenna portion may be shaped so as to optimise coupling with the device antenna.

Optionally, the first antenna portion and the second antenna portion are impedance matched. This may help to provide maximum power transfer between the first antenna portion and the second antenna portion.

Optionally, the antenna arrangement is passive. A passive antenna arrangement may be free of any powered circuitry, which may help to reduce the complexity of the antenna arrangement. This may help to reduce the likelihood of failures occurring within the antenna arrangement, and may also help to reduce the likelihood of the replacement or removal of the antenna arrangement being required and minimise maintenance. This may also help to reduce the overall power consumption of the system.

Optionally, the system comprises a plurality of antenna arrangements and/or a plurality of communication devices. This may help to provide redundancy and/or provide increased function to the system.

Optionally, the first antenna portion is configured to be electrically connected to the enclosure. This may provide an electrical ground between the antenna arrangement and the container which may increase the effectiveness/efficiency of the system. Optionally, the first antenna portion is configured to be electrically connected to the enclosure by an electrically conductive rivet. Optionally, the electrically conductive rivet is configured to secure the antenna arrangement to the enclosure. By using the same rivet to ground the antenna arrangement and to secure the antenna arrangement to the container, this may help to reduce the number of components required by the system which may reduce the complexity of the system.

Optionally, the transmitted signals comprise radio frequency (RF) signals. Optionally, the first antenna portion comprises at least a part of an RF repeater.

Optionally, the transmitted signals have a frequency of between 100 MHz and 60 GHZ. Optionally, the transmitted signals have a frequency of between 0.5 GHZ and 5 GHz. Optionally, the transmitted signals have a frequency between 2.4 GHz and 5 GHz. Optionally, the transmitted signals have a frequency between 2.4 GHz and 2.5 GHZ. This may allow the system to operate over a wide range of frequencies and may help to increase the versatility of the system.

Optionally, the communication device is an internet connectable device. Optionally, the communication device is connectable to a local network. Optionally, the communication device is wirelessly connectable to the local network. This may allow the communication device located externally of the enclosure to be monitored and/or controlled from a position remote from the enclosure.

Optionally, the first antenna portion is substantially free of sharp edges. This may help to reduce the likelihood of the first antenna portion damaging the contents of the enclosure.

Optionally, the first antenna portion comprises a planar antenna. This may help to improve the simplicity of manufacture of the first antenna portion. Optionally, the planar antenna comprises a substantially circular cross-sectional shape. This may help to reduce the likelihood of the first antenna portion damaging the contents of the enclosure.

Optionally, the first and second antenna portions are separate components physically attached to one another. In this way, the first and second antenna portions can be arranged internally within and externally of the enclosure respectively before being secured together. Optionally, the first antenna portion is attached to the second antenna portion through a hole in a wall of the enclosure. This may allow first and second antenna portions that may be too large to fit through the hole in the wall of the enclosure to be attached to one another. This may also make it easier to retrofit the system to existing enclosures.

Optionally, the first antenna portion and the second antenna portion are pre-assembled together before being passed through the hole in the wall of the enclosure. This may make it easier to install the antenna arrangement to the enclosure.

Optionally, the second antenna portion is attached to the first antenna portion by a nut secured to the second antenna portion. This may provide a simple and easy way to secure the first antenna portion to the second antenna portion. Moreover, the nut may be easily removed to allow the first antenna portion and/or the second antenna portion to be remove from the system, e.g. for replacement or repair. Optionally, the first antenna portion comprises an aperture through which a part of the second antenna portion is received. Optionally, the second antenna portion comprises a threaded region configured to engage with a corresponding threaded region of the nut to secure the nut to the second antenna portion.

Optionally, the first and second antenna portions are formed as a unitary item. This may help to reduce the complexity of the system. The first and second antenna portions may be moulded, cast, punched out of a sheet or 3D printed as a unitary item.

Optionally, the enclosure comprises a metallic material. Optionally, the enclosure comprises a shipping container.

Optionally, the communication device is arranged in a recess in a door of the shipping container. This may allow the communication device to be located such that it does not extend beyond an outer bound of the recess, which may help to protect the communication device from damage.

Optionally, the system comprises an insulating member located between the antenna arrangement and the enclosure. Optionally, the insulating member comprises a plastic. This may help to insulate the antenna arrangement from the enclosure, e.g. to prevent changes in the enclosure from affecting the antenna arrangement. The insulating member may also help to prevent unintended galvanic connections between the enclosure and the first and second antenna portions. This may help to control the position of an electrical ground between the antenna arrangement and the enclosure. The insulating member may also help to prevent damage occurring to the antenna arrangement when the antenna arrangement is installed in the hole in the wall of the enclosure.

According to a second aspect of the present invention, there is provided a system comprising: an antenna arrangement comprising: a first antenna portion configured to be located internally within an enclosure; and a second antenna portion configured to be located externally of the enclosure; and a communication device configured to be located externally of the enclosure, the communication device comprising a device antenna; wherein the device antenna is configured to be located such that the second antenna portion is in a near-field region of the device antenna such that the device antenna and the second antenna portion couple to one another to transmit signals between the communication device and the antenna arrangement.

Optionally, the antenna arrangement comprises an attachment feature for securing the antenna arrangement to the enclosure. The attachment feature may allow for easier connection of the antenna arrangement to the enclosure. The attachment feature may also help to provide a secure connection between the antenna portion and the enclosure. Optionally, the attachment feature comprises an electrically conductive rivet for securing the antenna arrangement to the enclosure.

According to a third aspect of the present invention, there is provided a transportation unit comprising the system according to the first aspect of the present invention or the second aspect of the present invention.

Optionally, the transportation unit comprises a vehicle (e.g. a marine vessel, an aircraft, a train or a motor vehicle). Optionally, the transportation unit comprises a control centre configured to communicate with the communication device. In this way, the control centre may control and/or monitor the communication device.

Optional features of aspects of the present invention may be equally applied to other aspects of the present invention, where appropriate.

### BRIEF DESCRIPTION OF DRAWINGS

Embodiments of the invention will now be described, by way of example only, with reference to the accompanying drawings, in which:

FIG. 1 shows a schematic side view of a container ship;

FIG. 2 shows a schematic isometric view of a shipping container;

FIG. 3 shows a schematic view of a system;

FIG. 4 shows a schematic partial cross-sectional view of the system of FIG. 3; and

FIG. 5 shows a schematic view of an antenna arrangement of the system of FIG. 3.

### DETAILED DESCRIPTION

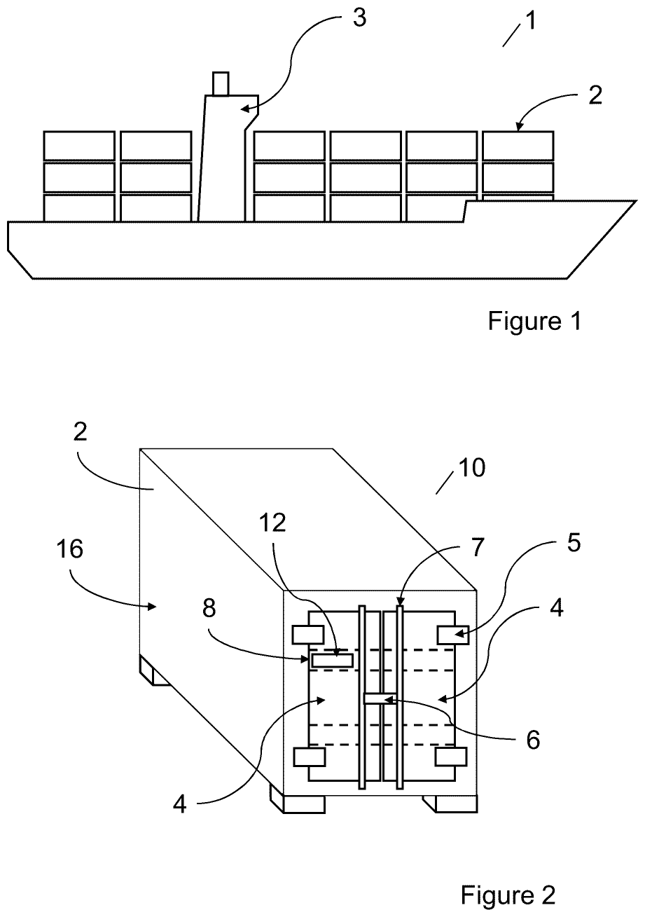

FIG. 1 shows a schematic side view of a marine vessel in the form of a container ship 1. A plurality of shipping containers 2 are stacked above a deck of the container ship 1. A bridge 3 is located on the container ship 1 from which operation of the container ship 1 may be controlled. The bridge 3 includes displays for displaying various details about the container ship 1 and/or the containers 2 along with inputs for controlling the container ship 1 and/or the containers 2.

A system 10 according to the present invention is schematically illustrated in FIGS. 2 to 5. FIG. 2 shows a schematic isometric view of the shipping container 2. The shipping container 2 comprises a plurality of walls 16, a pair of doors 4, first and second pairs of hinges 5, a pair of door bars 7, a lock 6, and a communication device 12.

The plurality of walls 16 are generally planar in form, are formed from a metallic material, and define an enclosure having an interior space 15. The doors 4 are also generally planar in form, albeit with recesses 8 formed therein, and are attached to one of the walls 16 by a respective one of the pairs of hinges 5. The door bars 7 and the lock 6 act to secure the doors 4 in a closed position, with the lock 6 operable by an actuator 25 (not visible) to lock and unlock the doors 4.

In use, it is desirable to monitor properties and/or statuses of the contents of the containers 2, or the containers 2 themselves. For example, the containers 2 may be refrigerated containers, also known as reefers and the temperature insider the reefer may be monitored to ensure that the temperature is kept at a desired value. However, as the containers 2 are metallic, they may act as a Faraday shield making it difficult to pass a signal from sensors or devices within the container 2 to the outside of the container 2, and/or vice versa. Therefore, the system 10 may provide an improved arrangement for transmitting signals, for example radio frequency (RF) signals, from outside the container 2 to inside the container 2, and/or vice versa.

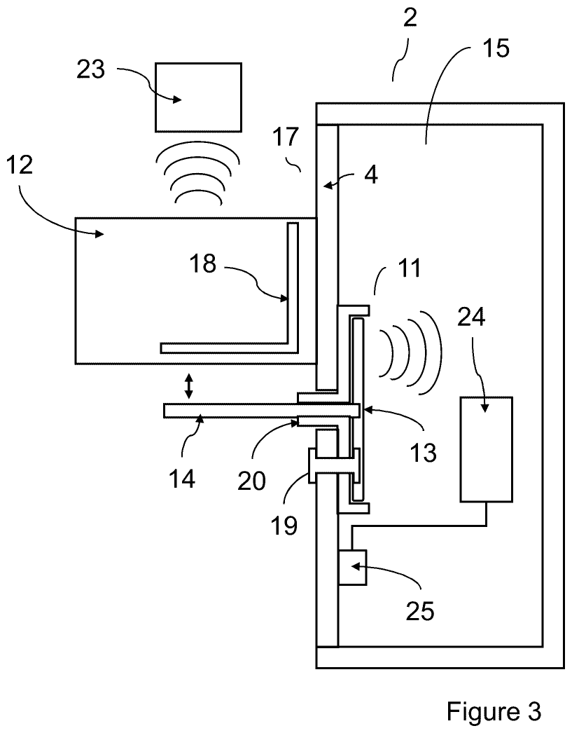

The system 10 (as shown in more detail in FIGS. 3 to 5) comprises the container 2, the communication device 12, an external device 23, an antenna arrangement 11, an insulating member 20, an electrically conductive rivet 19, a further communication device 12 and the actuator 25. The communication device 12 is located outside of the container 2 on an exterior 17 of the container 2 (i.e. externally of the container 2) within a recess 8 of the door 4 of the container 2 and comprises a device antenna 18. In some examples, the communication device 12 may alternatively be located on another part of the container 2, for example on one of the plurality of walls 16 of the container 2. The communication device 12 is in communication, such as through the internet, with the external device 23 via the device antenna 18. In some examples, the communication device 12 may comprise a plurality of device antennas 18. The communication device 12 acts to provide information indicative of the properties and/or statuses of the containers 2, or their contents, to the external device 23 and receive instructions from the external device 23.

The antenna arrangement 11 comprises a first antenna portion 13 and a second antenna portion 14 galvanically connected (e.g. directly electrically connected) together. The first antenna portion 13 and the second antenna portion 14 are asymmetrical and both comprise a metallic material. The first antenna portion 13 is located in the interior space 15 of the container 2 (i.e. internally within the container 2) on the door 4 of the container 2. The second antenna portion 14 passes through the door 4 and extends toward the exterior 17 of the container 2, such that the second antenna portion 14 is located within a near-field of the device antenna 18. The first antenna portion 13 is substantially planar and comprises a substantially circular shape which is free of sharp edges (as shown in FIG. 5). The first antenna portion 13 has a diameter of around 20 mm. In some examples, the first antenna 13 has a larger or a smaller diameter, such as between around 15 mm and 30 mm, and/or the first antenna portion 13 may comprise any other suitable cross-sectional shape, such as an elongate oval or a square. The second antenna portion 14 is elongate and has a length of around 20 mm. In some examples, the second antenna portion 14 has a larger or smaller length, such as between around 15 mm and 25 mm. The antenna arrangement 11 does not include any powered circuitry or power sources and is therefore passive. This means that the antenna arrangement 11 does not need to be connected to a power source to operate, which may help to increase the lifetime of the antenna arrangement 11 as there are no active components that may need to be replaced/replenished

The first and second antenna portions 13, 14 are separate components which are joined together to form the antenna arrangement 11. The first antenna portion 13 is joined to the second antenna portion 14 using a nut 21 which engages with a portion, e.g. a threaded portion, of the second antenna portion 14 which protrudes through a hole in the first antenna portion 13. In some examples, the first antenna portion 13 is secured to the second antenna portion 14 through other suitable means, such as through welding or adhesive.

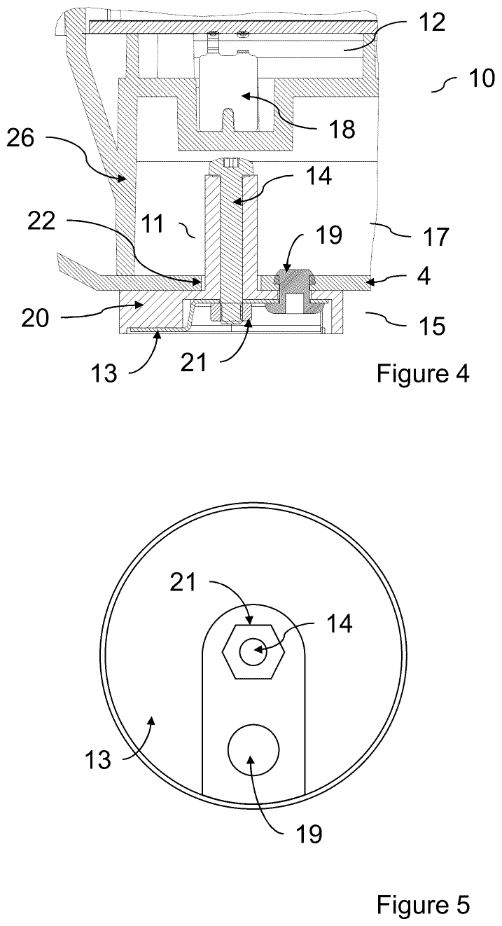

The antenna arrangement 11 passes through a hole 22 which is pre-formed in the door 4 of the container 2. The hole 22 is configured to receive the antenna arrangement 11 and provides an interface between the interior 15 and exterior 17 of the container 2. The insulating member 20 is located in the hole 22, between the antenna arrangement 11 and the door 4, and helps to insulate the antenna arrangement 11 from the container 2. As can be seen in FIGS. 3 and 4, the device antenna 18 and the second antenna portion 14 are located such that there is a gap between the device antenna 18 and the second antenna portion 14, i.e. there is no direct physical connection between the device antenna 18 and the second antenna portion 14. The device antenna 18 and the antenna arrangement 11 are arranged such that a part of a housing 26 of the communication device 12 is between the device antenna 18 and the second antenna portion 14. The housing 26 comprises a plastic but may also comprise any other non-electrically conductive material.

The electrically conductive rivet 19 extends through the first antenna portion 13 and the door 4 and acts to secure the antenna arrangement 11 to the door 4, while also electrically grounding the antenna arrangement 11 to the container 2. To help to ensure maximum power transfer between the first antenna portion 13 and the second antenna portion 14 in use, the first and second antenna portions 13, 14 are impedance matched. In some examples, another property of the first antenna portion 13 is matched to a corresponding property of the second antenna portion 14, such as a physical dimension

The further communication device 24 is located inside 15 the container and in a far-field region of the first antenna portion 13. The further communication device 24 is connected to the actuator 25 which is configured to actuate the lock 6 of the container 2. Although only one further communication device 24 is shown in FIG. 3, in some examples a greater number of further communication devices 24 may be provided. In some examples, the further communication device 24 comprises or is in communication with a sensor or an identification module. The sensor may be a temperature sensor to monitor the internal temperature of the container 2 and the identification module may be an RFID module containing information relating to the container 2 or its contents. In some examples, the further communication device 24 comprises or is in communication with multiple sensors and/or identification modules.

The device antenna 18 and the antenna arrangement 11 are each configured to transmit and receive signals. The signals have a frequency of between 100 MHz and 60 GHZ. In some examples, the signals have a frequency of between 0.5 GHZ and 5 GHZ, between 2.4 GHz and 5 GHZ, or between 2.4 GHz and 2.5 GHz. In some examples, the signals comply with the Bluetooth standard.

As discussed above, the second antenna portion 14 is located within the near-field region of the device antenna 18. In general, the size of the near-field region is dependent on the size of the emitting antenna (in this case the device antenna 18) and the wavelength of the signals (i.e. radiation) being transmitted. In the system of FIGS. 3 to 5, the device antenna 18 is shorter than a wavelength of the radiation. In this example, the device antenna 18 has a length of around 10 mm. In other examples, the device antenna 18 has a length greater or smaller than 10 mm, such as around 5 mm, 15 mm or 20 mm. As such, the near-field region is within around one wavelength of the device antenna 18 and the region more than around two wavelengths from the device antenna 18 is the far-field region. The region between around one wavelength and two wavelengths is known as the transition zone where the near-field behaviour dies out and far-field effects become dominant.

Alternatively, when an antenna is physically larger than a half-wavelength of the radiation being emitted, the near and far fields are defined in terms of the Fraunhofer distance d_{F}, which is defined by:

$${d}_{F} = \frac{2 {D}^{2}}{λ}$$

where D is the physical length of the antenna (i.e. the larger dimension of the antenna) and λ is the wavelength of the emitted radiation. The Fraunhofer distance provides the limit between the near-field region and the far-field region.

By being within the near-field region of the device antenna 18, the second antenna portion 14 is coupled to the device antenna 18 such that signals emitted by the device antenna 18 are transmitted to and received by the second antenna portion 14. Additionally, the device antenna 18 is also located within the near-field region of the second antenna portion 14 and is coupled to the second antenna portion 14. In this way, further signals emitted by the second antenna portion 14 (e.g. those received by the first antenna portion 13 from within the container 2) are transmitted to and received by the device antenna 18. This helps to ensure that coupling between the device antenna 18 and the second antenna portion 14 occurs whether the signals are transmitted into, or out of, the container 2.

The gap between the device antenna 18 and the second antenna portion 14 means that the coupling between the device antenna 18 and the second antenna portion 14 occurs without any physical connection between the device antenna 18 and the second antenna portion 18 and instead occurs through near-field interactions between the device antenna 18 and the second antenna portion 14. This may allow for the communication device 12 to be removed from the container 2 without also having to remove the antenna arrangement 11. In this way, the communication device 12 may be easily removed for repair or replacement, for example, to upgrade the communication device 12. This may help to improve the lifetime of the antenna arrangement 11 and may help to reduce waste created from having to replace the antenna arrangement 11.

Although the antenna arrangement 11 is described above as being secured to the container by the electrically conductive rivet 19, in some examples the rivet 19 is omitted. The antenna arrangement 11 may be secured to the container 2 by another means, such as by an adhesive or through an interference fit between the antenna arrangement 11 and the container 2. In some examples, the rivet 19 is replaced with another suitable electrically conductive securing device, e.g. an electrically conductive bolt.

As described above, the communication device 12 is in communication with the external device 23 via the device antenna 18. This means that the same device antenna 18 is used to communicate with the external device 23 as is coupled to the second antenna portion 14. In some examples, the communication device 12 is in communication with the external device via a direct wireless connection, e.g. through a local network without an internet connection. In use, the external device 23 receives information from the communication device 12 indicative of a status and/or property of the container 2. This may allow the communication device 12, and the container 2, to be monitored remotely from the container 2. The external device 23 may display this information, for example in the bridge 3 of the ship 1, to allow a user to monitor the container 2 and/or is content.

The communication device 12 is configured to receive instructions from the external device 23 and to transmit signals to the further communication device 24 in response to the instructions. In use, the communication device 12 receives the instructions from the external device 23 (for example, instructions input by the user from the bridge 3 of the ship 1) and transmits signals via the device antenna 18. When the instructions are, for example, to actuate the lock 6 of the container 2, the communication device 12 transmits signals indicative of the instructions to actuate the lock 6. The signals are received by the second antenna portion 14, which is located in the near field region of the device antenna 18. The signals then pass from the second antenna portion 14 (located externally of the container 2) to the first antenna portion 13 (located internally within the container 2) and are emitted by the first antenna portion 13 into the interior of the container 2, where they are received by the further communication device 24 within the container 2. The further communication device 24 then causes operation of the actuator 25 to actuate the lock 6. This allows the lock 6 to be actuated, and therefore the container 2 to be secured or unsecured, remote from the container 2. Either in response to the signals received from the communication device 12, or separately, further signals are emitted by the further communication device 24 which are received by the first antenna portion 13. These further signals pass from the first antenna portion 13 to the second antenna portion 14, where they are then transmitted to the device antenna 18 which is within the near-field region of the second antenna portion 14. These further signals are subsequently transmitted to the external device 23 to be displayed to a user or further analysed.

Although the system 10 discussed above is described with reference to a shipping container 2, the system 10 may be used with other enclosures. For example, the enclosure may be a part of a vehicle (e.g. a marine vessel, an aircraft, a train or a motor vehicle) or may be another enclosed space (such as a sealed room, an elevator, a building, etc).

Example embodiments of the present invention have been discussed, with particular reference to the examples illustrated. However, it will be appreciated that variations and modifications may be made without departing from the scope of the invention as defined by the appended claims.

What is claimed is:

1. A system comprising:
an enclosure;
an antenna arrangement comprising:
a first antenna portion located internally within the enclosure; and
a second antenna portion located externally of the enclosure; and
a communication device located externally of the enclosure, the communication device comprising a device antenna;
wherein the second antenna portion is located in a near-field region of the device antenna such that the device antenna and the second antenna portion couple to one another to transmit signals between the communication device and the antenna arrangement.

2. The system according to claim 1, wherein the device antenna is located in a near-field region of the second antenna portion.

3. The system according to claim 1, wherein the system comprises a further communication device located internally within the enclosure, and the antenna arrangement is configured to transmit signals between the first antenna portion and the further communication device.

4. The system according to claim 3, wherein the further communication device comprises at least one of: a sensor and an identification module.

5. The system according to claim 3, wherein the further communication device comprises a temperature sensor to determine a temperature within the enclosure.

6. The system according to claim 3, wherein the further communication device comprises at least one of: a vibration sensor, a shock sensor, a gas sensor, a light sensor, a humidity sensor and an event sensor.

7. The system according to claim 3, wherein the further communication device is located in a far-field region of the first antenna portion.

8. The system of claim 1, wherein the antenna arrangement is passive.

9. The system according to claim 1, wherein the first antenna portion is electrically connected to the enclosure.

10. The system according to claim 1, wherein the first antenna portion is substantially free of sharp edges.

11. The system according to claim 1, wherein the first antenna portion comprises a planar antenna.

12. The system according to claim 1, wherein the first and second antenna portions are separate components physically attached to one another.

13. The system according to claim 1, wherein the enclosure comprises a shipping container.

14. A system comprising:
an antenna arrangement comprising:
a first antenna portion configured to be located internally within an enclosure; and
a second antenna portion configured to be located externally of the enclosure; and
a communication device configured to be located externally of the enclosure, the communication device comprising a device antenna;
wherein the device antenna is configured to be located such that the second antenna portion is in a near-field region of the device antenna such that the device antenna and the second antenna portion couple to one another to transmit signals between the communication device and the antenna arrangement.

15. A transportation unit comprising the system according to claim 14.
